(19) United States
(12) Patent Application Publication
(10) Pub. No.: US 2017/0351415 A1
(43) Pub. Date: Dec. 7, 2017

(54) SYSTEM AND INTERFACES FOR AN INTERACTIVE SYSTEM

(71) Applicant: Jonathan K. Cheng, Cambridge, MA (US)

(72) Inventor: Jonathan K. Cheng, Cambridge, MA (US)

(21) Appl. No.: 15/182,175

(22) Filed: Jun. 14, 2016

Related U.S. Application Data
(60) Provisional application No. 62/345,961, filed on Jun. 6, 2016.

(51) Int. Cl. G06F 3/0484; G06F 3/00; H04N 9/31

(52) U.S. Cl. CPC G06F 3/04847; H04N 9/3185; G06F 3/005; G06F 3/04842

(57) ABSTRACT

A system is provided that is capable of storing and presenting within an interface, interactive content. For instance, it is appreciated that there may be a need to effectively present interactive content at a customer site using standard computer equipment. Also it may be beneficial to provide user tools to easily calibrate the system and customize the interactive content to suit the particular interactive content and environment. A distributed system permits the use, customization and display of interactive content among a number of various site locations.

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### RELATED APPLICATION

This application claims priority to claims priority under 35 U.S.C. §119(e) to U.S. Provisional Patent Application Ser. No. 62/345,961 entitled “SYSTEM AND INTERFACES FOR AN INTERACTIVE SYSTEM” filed Jun. 6, 2016, hereby incorporated by reference in its entirety.

### BACKGROUND

Systems exist that permit users to interact with computer systems in a variety of ways. For instance, there are computer systems that permit the display of information that is projected on a screen. Many of these systems involve specialized projectors that are integrated with specialized computer systems, such as those that are used in classroom applications. For instance, there are projectors that permit use of a whiteboard area as a display, and use special pens and other elements to determine where a user is providing input (e.g., writing on a whiteboard).

### SUMMARY

It is appreciated that it would be beneficial to provide an interface that can use common components (e.g., computers, webcam and projectors) to provide an interactive system that can be used for a number of different application and settings. For instance, such a system may be supported in an ad hoc way in a public setting such as a climbing gym, a museum, an auditorium, or other forum that can support an ad hoc activity. Existing systems and software tools are not sufficient to support such displays in an ad hoc manner, as they require expensive equipment that requires professional installation and setup. Further, it is appreciated that such ad hoc uses cannot justify such expensive systems.

What is needed is a system and associated interfaces that permit users to create an interactive system in an ad hoc way using conventional components, such as a webcam, a standard projector and computer system. In particular, a standard projector may be coupled to a typical computer with a camera, which is coupled to a communication network. Specialized software may be provided that permits the computer to display interactive content on a surface, and the camera of the computer system is capable of capturing video that can be used by the computer system to detect interactions (e.g., human interaction) with the displayed interactive content. Because these systems are decoupled (e.g., the projector is not integrated with the camera), tools may be provided that allow the user to easily calibrate the system.

For instance, it is appreciated that there may be provided a user interface that permits the user to define an interactive area within a computer interface that displays captured video of a surface or other shape or element of a location. For instance, a standard climbing wall may be transformed into an interactive game area. In another example, an augmented reality game may be provided in a gym, yoga studio, etc. that includes interactive elements displayed within the location. Other areas, such as museums, trampoline parks, shopping centers, airports, or other locations may be used to present interactive content by such a system.

In one embodiment, a tool is provided that allows the user to indicate, to the computer system, a definition of an interactive area within an area captured by the camera. At least a portion of the interactive area overlaps a display area of the projector display area, and interactions with elements that are displayed in the interactive area are captured by the camera. According to one embodiment, the system provides an editing environment for designing interactive content. In particular, the interface permits creation of the interactive content at a customer site using conventional computer elements and projectors, and the interactive content is hosted at a central location (e.g., in the cloud). Further, a distributed system permits the use, customization and display of interactive content among a number of various site locations. Users may subscribe to interactive content using standard, user-supplied equipment to create and display interactive content. In another implementation, a kit is provided that provides a camera, projector, and downloaded software that can be set up for use at a particular customer site.

According to another aspect of the present invention, a system is provided that combines an interface for projection mapping along with a method for performing motion capture for use as an interactive system. In one embodiment, the projection mapping provides the interface and configuration that permits the user to adapt the interface to conform to a particular surface (e.g., a wall). The interface allows the user to change a geometry of motion captured areas within the interface.

According to one aspect of the present invention, a system is provided comprising a projector, a camera, and a computer system coupled to the processor, the computer system comprising at least one processor operatively connected to a memory, the at least one processor, when executing is configured to operate the projector to display interactive content on a surface, operate the camera to capture at least image of the displayed interactive content, and an alignment tool adapted to align a component within the captured at least one image and a computer-generated representation of the interactive content. According to one embodiment, the at least one processor is further configured to store alignment information in the memory.

According to another embodiment, the at least one processor is further configured to present, within a display of the computer, an editor interface including a control that permits a user to associate an interactive element with the component within the display. According to another embodiment, the system further comprises at least one user interface control that when selected, permits a user to select an interactive element and position the element over a captured aspect of a real-world element, and that causes the at least one user interface to project the element over the real-world element.

According to another embodiment, the camera is adapted to capture a real-world interaction with the projected element. According to another embodiment, the real-world element is a climbing element within a climbing course. According to another embodiment, the system further comprises at least one control that permits the user to define behavior of the interactive element within the display.

According to another embodiment, the behavior comprises visual appearance of the interactive element. According to another embodiment, the at least one processor is further configured to present, within a display of the computer, one or more controls that permit a user to adjust image processing behavior.

According to another embodiment, the one or more controls comprises at least one control adapted to change sensitivity to a real-world action that triggers a selection of a projected interactive element. According to another embodiment, the one or more controls comprises at least one control adapted to adjust a lighting control for adjusting parameters relating to processing captured images at a particular site location.

According to another aspect of the present invention, in a system comprising a projector, camera and computer system, a method comprising operating the projector to display interactive content on a surface, operating the camera to capture at least image of the displayed interactive content, and aligning, by an alignment tool provided by the computer system, a component within the captured at least one image and a computer-generated representation of the interactive content. According to one embodiment, the method further comprises an act of storing, in a memory of the computer system, alignment information.

According to another embodiment, the method further comprises an act of displaying, within a display of the computer, an editor interface including a control that permits a user to associate an interactive element with the component within the display. According to another embodiment, the method further comprises an act of permitting a user, via at least one user interface control that when selected by the user, to select an interactive element and position the element over a captured aspect of a real-world element, and in response, causing the at least one user interface to project the element over the real-world element. According to another embodiment, the method further comprises an act of capturing a real-world interaction with the projected element.

According to another embodiment, the real-world element is a climbing element within a climbing course. According to another embodiment, the method further comprises an act of permitting a user, via at least one control, to define behavior of the interactive element within the display. According to another embodiment, the behavior comprises visual appearance of the interactive element.

According to another embodiment, the method further comprises an act of presenting, within a display of the computer, one or more controls that permit a user to adjust image processing behavior. According to another embodiment, the one or more controls comprises at least one control adapted to change sensitivity to a real-world action that triggers a selection of a projected interactive element. According to another embodiment, the one or more controls comprises at least one control adapted to adjust a lighting control for adjusting parameters relating to processing captured images at a particular site location.

According to another aspect of the present invention, a non-volatile computer-readable medium encoded with instructions for execution on a computer system. The instructions when executed, provide a system comprising a projector, a camera, and a computer system coupled to the processor, the computer system comprising at least one processor operatively connected to a memory, the at least one processor, when executing is configured to operate the projector to display interactive content on a surface, operate the camera to capture at least image of the displayed interactive content, an alignment tool adapted to align a component within the captured at least one image and a computer-generated representation of the interactive content. Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “ this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows a block diagram of a distributed computer system capable of implementing various aspects of the present invention;

FIG. 2 shows an example process for presenting interactive content according to one embodiment of the present invention;

FIG. 3 shows an example process for calibrating an interactive system according to one embodiment of the present invention;

FIG. 4 shows another example process for calibrating an interactive system according to one embodiment of the present invention;

FIG. 5 shows an example process for designing a game using an interactive system according to one embodiment of the present invention;

FIG. 6 shows an example user interface according to various embodiments of the present invention;

FIG. 7 shows an example user interface with various user controls according to various embodiments of the present invention;

FIG. 8 shows an example user interface used to design an interactive game according to various embodiments of the present invention;

FIG. 9 shows an example user interface used to present an interactive game according to various embodiments of the present invention; and

FIG. 10 shows an example user interface that shows an interactive game element according to various embodiments of the present invention.

### DETAILED DESCRIPTION

According to one implementation, a system is provided that is capable of storing and presenting within an interface, interactive content. For instance, it is appreciated that there may be a need to effectively interactive content at a customer site using standard computer equipment. Also it may be beneficial to provide user tools to easily calibrate the system and customize the interactive content to suit the particular content. Typical interactive systems generally require expensive, customized hardware that is installed by professional technicians.

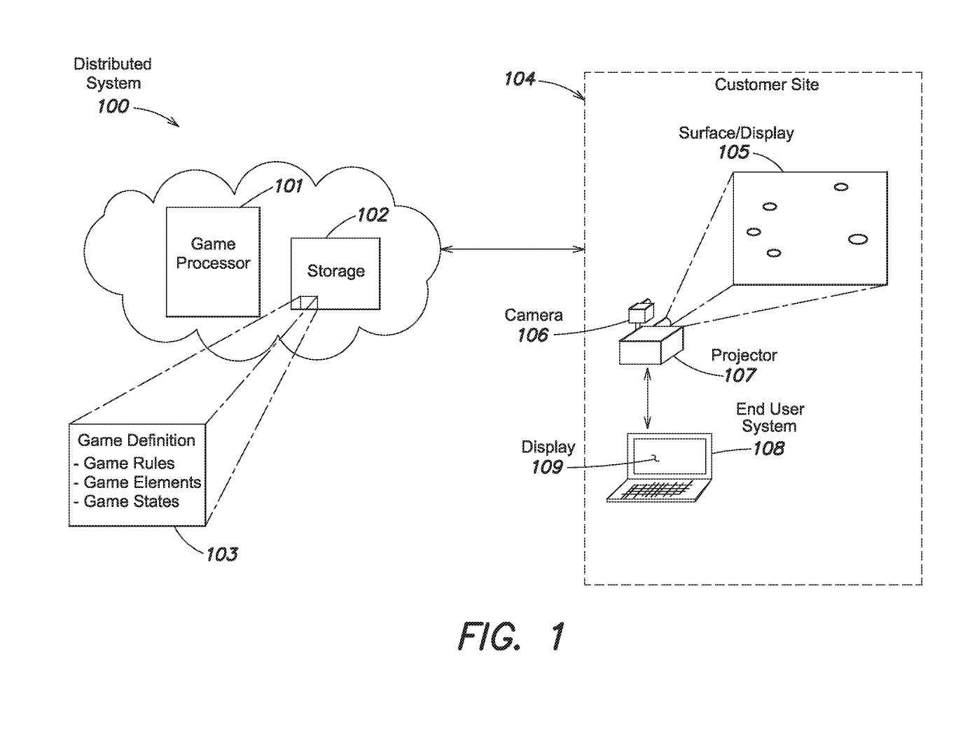

FIG. 1 shows a block diagram of a distributed computer system 100 capable of implementing various aspects of the present invention. In particular, distributed system 100 includes one or more computer systems operated by a user and a virtualized game system that is accessed by the computer system through a communication network (e.g., the Internet). Generally, users may access the distributed system through a client application that is executed on one or more of end systems (e.g., end user system 108). End user systems 108 may be, for example, a desktop computer system, mobile device, tablet or any other computer system having a display.

As discussed, various aspects of the present invention relate to interfaces through which the user can interact with interactive content system. To this end, users may access the interactive content system via the end user system (e.g., system 108) and/or one or more real-world interactive interfaces provided by the computer system via a projector (e.g., projector 107) and a camera (e.g., camera 106).

According to one embodiment, the projector 107 displays computer generated content on the surface/display 105. For instance, the surface may be a flat surface such as a wall, screen, or other element displayed within the real world. Camera 106 may be used to collect video information relating to any interaction with the displayed computer generated content provided by the projector. Based on video information collected by the camera, the computer (e.g., end-user system 108) may detect the interaction and provide revised content to be displayed to the user via the projector. In this way, a user may interact with the interactive content system using only the surface/display 105.

To this end, within the display, may be provided one or more interactive elements that can be selected and/or manipulated by the user. Such interactive elements may be, for example, game elements associated with a computer game. To accomplish this, distributed system 100 may include a game processor 101, storage 102, and one or more game definitions 103. Game processor 101 may include one or more hardware processors that execute game logic, store game states, and communicate with end-user systems for the purpose of executing a game program at a customer site (e.g., customer site 104).

The game definition may be provided, for example, by an entity that maintains a game server. For instance, the game may be a real-world climbing game conducted at a climbing gym including a number of real world climbing elements along with virtual interactive elements that may be activated by participants in the climbing game. Although it should be appreciated that any of the aspects described herein can be implemented in the climbing game, it should be appreciated that aspects may be implemented in other environments that have real-world features, such as, for example, museums, gyms, public displays, or any other location that can benefit from real-world interactive content.

The game definition may include one or more game rules involving one or more game elements (e.g., information that identifies elements that can be displayed and interacted with within the real world). Storage 102 may also include other information such as game state information that identifies a current game state of a particular game instance. In one embodiment, the system is implemented on a cloud-based system wherein multiple sites may communicate to the game server system and service. In one embodiment, software may be downloadable to a conventional computer system using a conventional web camera and standard projector, allowing a typical end-user to create an interactive system without needing specialized hardware. The software may include components that access the camera and output information on the projector and coordinate the detection of movement in relation to the information displayed by the computer via the projector.

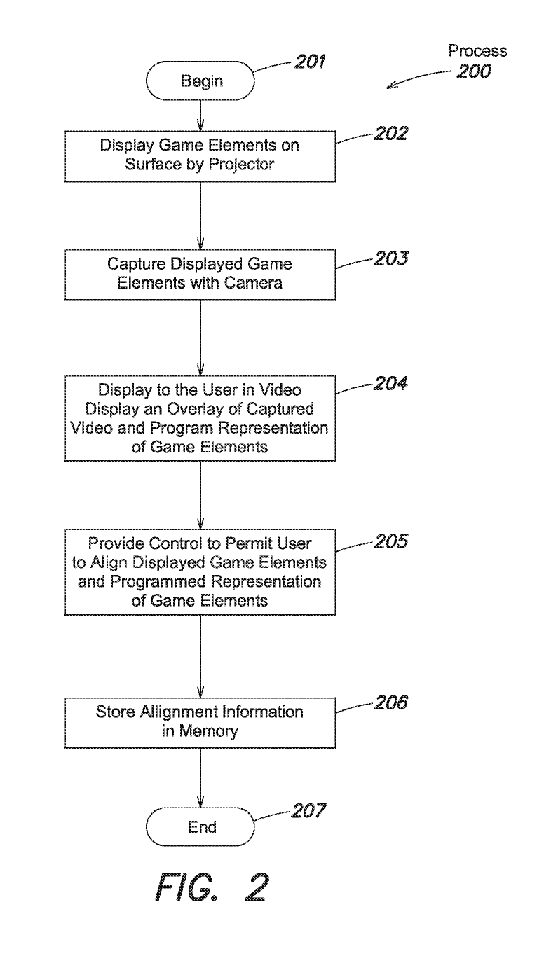

FIG. 2 shows an example process 200 for presenting interactive content according to one embodiment of the present invention. At block 201, process 200 begins. At block 202, game elements are displayed on a surface by the projector. For instance, one or more game elements may be arranged on an interface by a user of the computer system, in these game elements are displayed on predefined locations in relation to an image that is displayed by the projector on the surface (e.g., a wall).

At block 203, the system captures the displayed game elements with a camera (e.g., a web cam coupled to the computer system). At block 204, the system displays to the user in the video display and overlay of the captured video and a programmable representation of game elements. For instance, the system may include a representation of the captured video along with a logical representation of the area in which interactive game elements are placed. This may be accomplished by, for example, overlaying graphical elements on a representation of the captured video.

At block 205, the system may provide a control to the user that permits the user to align displayed game elements and a programmed representation of the game elements. For example, if there are one or more real-world game elements, these elements may be captured by the camera and the user may be able to align virtual game elements with the captured representation. In one example, the user is allowed to define a field (e.g., by a rectangle or other shape) in which interactive elements may be placed. Further, interactive virtual game elements may be aligned with actual real-world game elements. In the case of a climbing wall game, hold locations (e.g., real-world game elements) may be aligned to interactive game elements (e.g., an achievement that can be activated by a user within the real world).

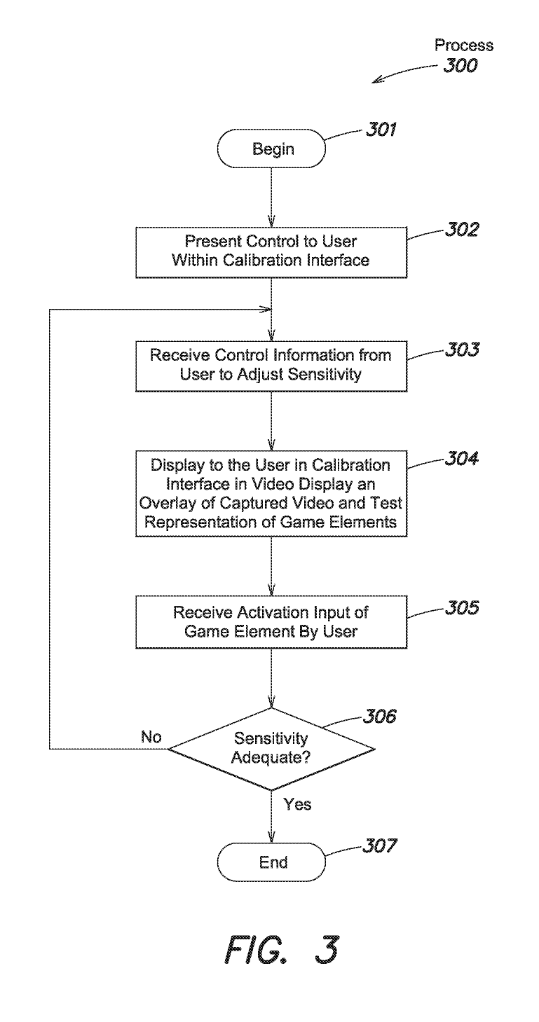

FIG. 3 shows an example process 300 for calibrating an interactive system according to one embodiment of the present invention. At block 301, process 300 begins. At block 302, the system (e.g., end-user system 108) presents a control to the user within a calibration interface. For instance, because the camera, computer system, and projector are not tightly coupled, calibration interface is provided to adjust collection of inputs captured by the video camera in front of the information displayed by the projector. According to one implementation, both the camera and projector are pointed to the same general area, and the system allows for an alignment to interactive display data being projected by the projector and captured image data received from the camera.

Further, at block 303, the system receives control information from the user to adjust the sensitivity. For instance, the system may be adjusted to sense different actions as selection events within the interface. By adjusting the sensitivity to be more sensitive, less action is required on behalf of the user to activate a particular displayed control. In one embodiment, the sensitivity may include the sensitivity of the projected interface control to motion of an image captured by the camera.

At block 304, the system displays to the user within the calibration interface (e.g., in video display 109) and overlay of captured video and a test representation of game elements. For instance, within the calibration display, a number of test controls may be provided that permits the user to adjust an alignment between the controls displayed by the projector and the control inputs as detected by the video camera. According to one embodiment, the system may permit the user to adjust (e.g., by stretching, offsetting, or other adjustment) of an input display definition that defines the control inputs over the actual displayed information by the projector. In this way, the user may adjust the geometry of the control input area, which can be customized to the particular environment. At block 305, the system may receive an activation input of the game elements by user (e.g., for test purposes).

At block 306, it is determined whether the sensitivity is adequate depending on the user input and whether the game element was activated satisfactorily. If not, the user may adjust the sensitivity either up or down accordingly to achieve the desired result. If the sensitivity is deemed adequate at block 306, the process ends at block 307, after which a game may be designed or played.

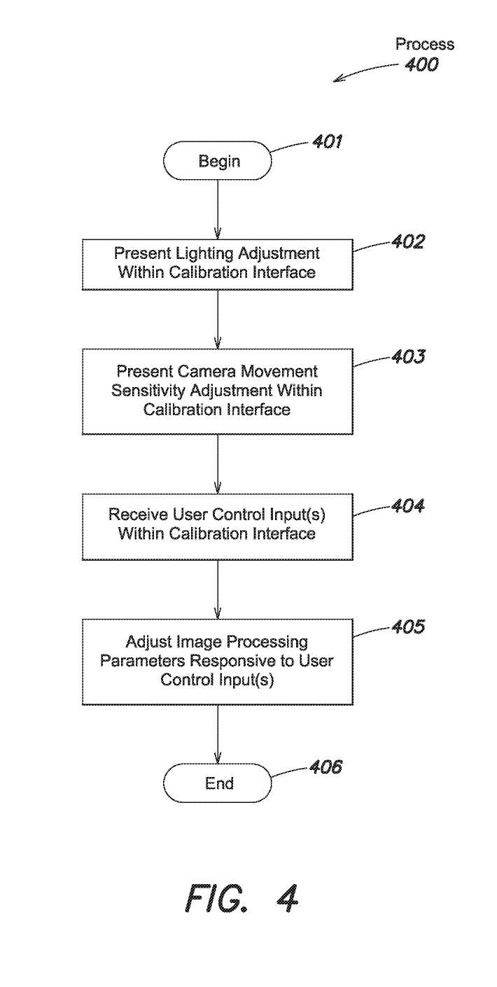

FIG. 4 shows another example process 400 for calibrating an interactive system according to one embodiment of the present invention. At block 401, process 400 begins. At block 402, the system presents a lighting adjustment within the calibration interface. For instance, it is appreciated that depending on the environment, the lighting situation may be various, and therefore it may be useful to present a lighting adjustment that can be adjusted as required by user at the installation location.

At block 403, the system may also present a camera movement sensitivity adjustment within the calibration interface. For instance, the system may be capable of sensing different levels of movement, and depending on the game or other presentation format, it may be desired to change this control. At block 404, the system receives user control inputs within the calibration interface of one or more adjustments. At block 405, the system adjusts image processing parameters responsive to the user control inputs. At block 406, process 400 ends.

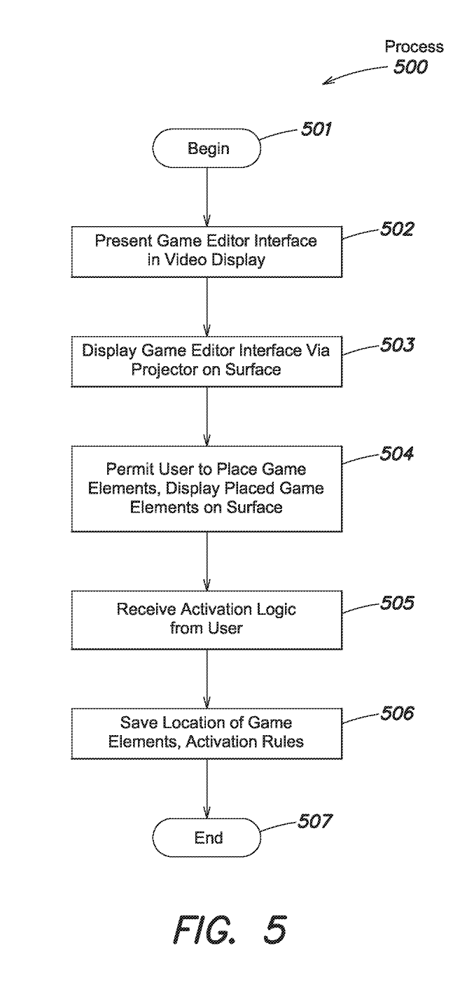

FIG. 5 shows an example process 500 for designing a game using an interactive system according to one embodiment of the present invention. At block 501, process 500 begins. At block 502, the system presents game editor interface within a video display of a computer system (e.g., display 109 of end user system 108). In particular, according to one aspect, a user is permitted to create various instantiations of an interactive game (or other interactive display) within an editor interface. Within this editor, the user is permitted to drag-and-drop particular game elements, define behavior of the game responsive to particular inputs, and align particular game elements with real world entities. In the case of a climbing game, certain game elements may be aligned to areas in the real world such as a climbing hold or other element of achievement.

At block 503, the system displays game editor interface via the projector on a surface. In one embodiment, the surface is a wall surface such as a climbing area within a climbing gym. At block 504, the system permits the user to place game elements, and display those placed game elements on the surface. As discussed above, game elements may be placed over particular hold locations in a climbing game.

At block 505, the system receives activation logic from a user. For instance, the system may require that the user activate a particular control for a certain amount of time. Also, particular game elements may have certain behaviors, when activated. At block 506, the system sees the location of one or more game elements, and their associated activation rules. For example, such information may be stored in a distributed system (e.g., distributed system 100) as a game definition that can be executed by one or more computer systems. In one embodiment, a number of predetermined games may be defined and played at a number of different locations. At block 507, process 500 ends.

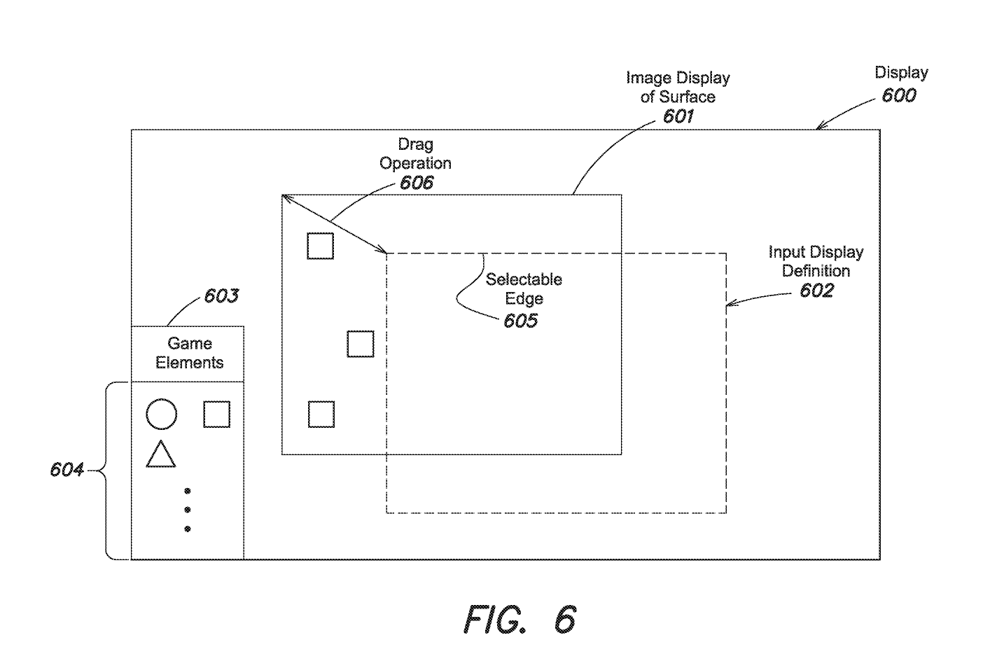

FIG. 6 shows an example user interface according to various embodiments of the present invention. In particular, FIG. 6 shows a display 600 that may be provided on a computer system at a customer site (e.g., end-user system 108). Display 600 may include a number of images that permit the user to calibrating an interactive system, design games or other game content, and/or any other type of interactive content.

In particular, display 600 may include an image display of the surface 601. This image may be a displayed video image of the real world surface (e.g., a wall) that is being captured currently using the camera (e.g., a web cam coupled to the computer system). Display 600 may also include an input display definition 602 in which are detected interactions. Also, within the input display definition 602, one or more game elements (e.g., 603) may be provided in place by user to correspond with detected areas within the real world (e.g., detecting interactions along the surface of a wall).

Game elements 603 may include one or more different types of elements 604. These different types of elements may exhibit different behaviors and/or have different activation logic associated with them. The user may selectively place different types of elements to create a particular game and/or interactive content. According to one embodiment, in one operation, the user may be permitted to move the input display definition 602 to align with an image display of the surface (e.g., 601). The user may use a pointing device to “grab” a selectable edge 605 which can be used to reposition input display definition 602 using a drag operation 606. In this way, the input display definition 602 may be aligned with an image display of the surface 601. However, it should be appreciated that other input types may be used to reposition input display definition 602 (e.g., a keyboard input, programmatic input, other physical control input, etc.).

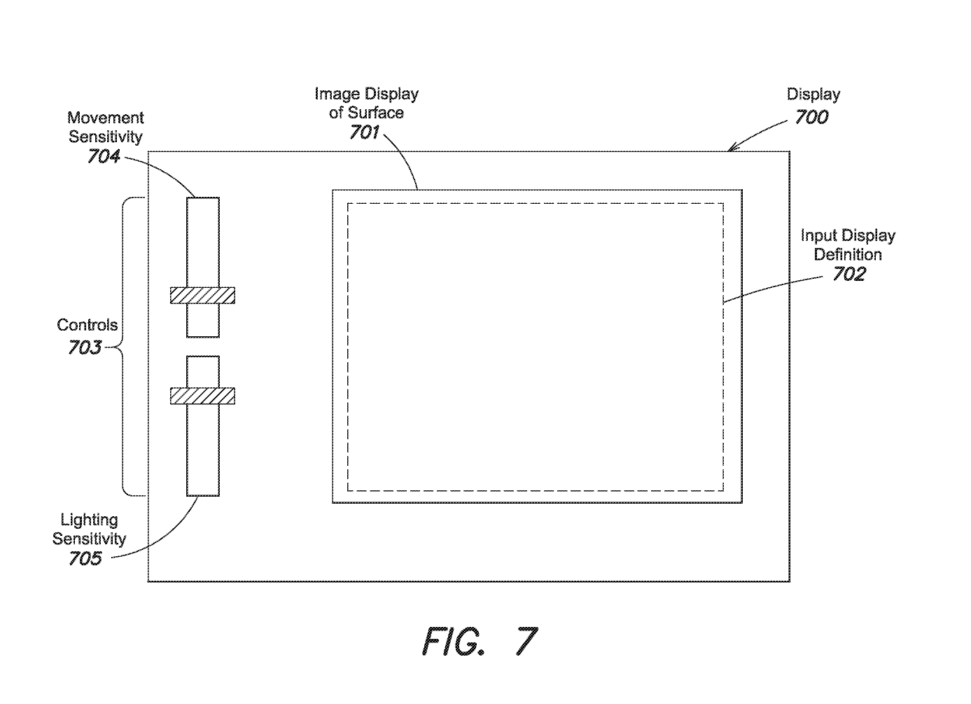

FIG. 7 shows an example user interface with various user controls according to various embodiments of the present invention. As discussed above, because there may be a variety of public display areas, applications, and possible games or interactive content that may be used with the system, a number of controls (e.g., controls 703 may be provided to account for differences within the environment and application. To this end, a display 700 may be provided on a local computer system (e.g., end-user system 108) that permits the user to adjust particular aspects of how the captured images are processed.

For example, display 700 may include an image display of a surface 700 and an input display definition 702 similar to those as discussed above with reference to FIG. 6. Display 700 may also include one or more control, 703 that compensate for movement and lighting. For example, display 700 may include a movement sensitivity control 704 that compensates for movement within the display. Such movements may be used to determine whether a particular element is activated (or not) based on the movement type. If set to a lower sensitivity, smaller movements such as those by the hand may be used to activate a particular game element or other interactive element type. If set to a high sensitivity, it may take more interaction with the game element to cause particular game element to be activated (e.g., a length or duration of activation). Display 700 may also include the lighting sensitivity control 705 which can be used to compensate for actual lighting conditions at the customer site location. For instance, if dimly lit, activation of particular elements may not be detected. Therefore, the user may adjust the lighting sensitivity control to more adequately detect activations of certain elements within various environments.

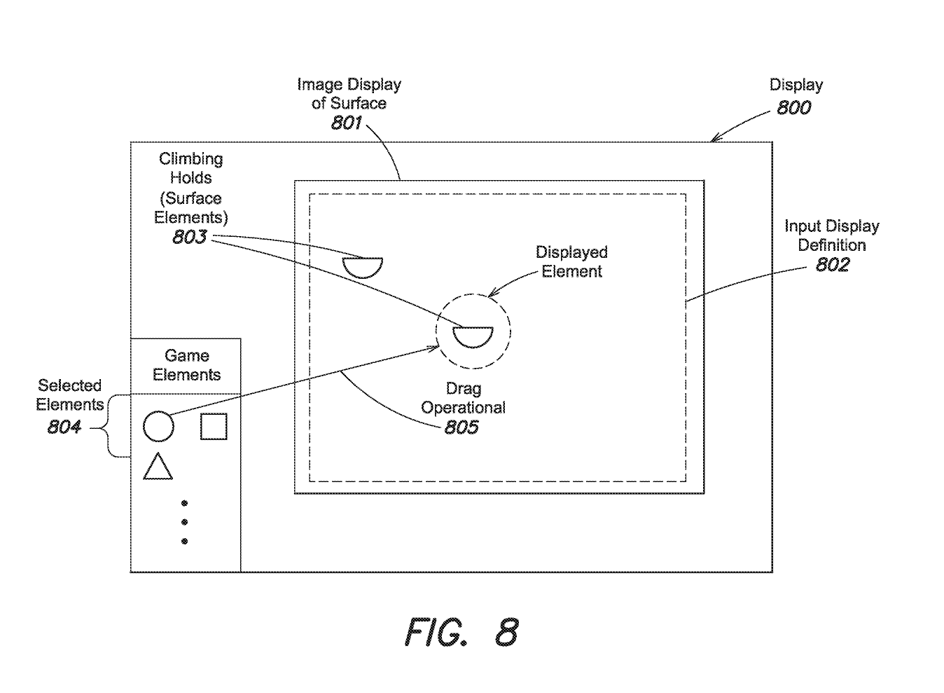

FIG. 8 shows an example user interface used to design an interactive game according to various embodiments of the present invention. In particular, FIG. 8 shows a display 800 that includes controls that permit the user to design interactive content according to various aspects. In particular, display 800 includes an image display of a surface 801, as discussed above with reference to FIGS. 6 and 7. In one embodiment, a climbing game may be designed by a user at a customer site such as a climbing gym. In particular, there may be one or more surface elements (e.g., climbing holds) that are positioned long the surface where the interactive content will be displayed. For instance, one or more climbing holds 803 may be positioned along the wall, and the video capture of the image display of the surface it 801 may show those surface elements within display 800. The user may be permitted to define one or more game elements which are co-located with the surface elements within the display. In one embodiment, the user may select one or more elements 804 and, using a drag operation 805, position one or more elements within the display 800. In particular, the user may place a displayed element within the input display definition 802. In one embodiment, the interface may allow for calibrating moving surface elements by allowing the user to define the path of the moving element by mouse dragging or other method.

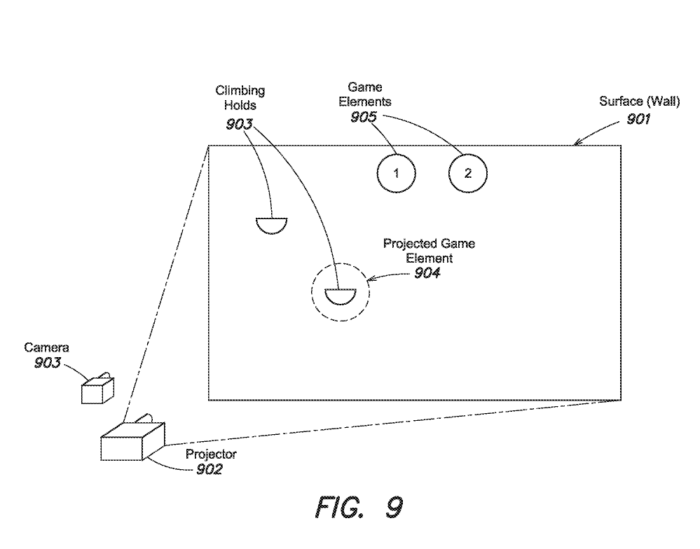

FIG. 9 shows an example user interface used to present an interactive game according to various embodiments of the present invention. In particular, FIG. 9 shows a surface 901 on which is displayed in interactive game using a standard projector 902 and camera 903 integrated with the computer system (not shown). In particular, projector 902 projects interactive content on a surface such as a wall. In one embodiment, the interactive content is a game that is integrated with a climbing gym and wall having one or more climbing holds 903 on which is projected at least one game element (e.g. projected game element 904). The wall may include other game elements displayed on the wall such as game elements 905. In one particular game format, the game requires that certain elements are activated in particular order, therefore, elements have indications identifying which order each elementary activated (e.g., by a climber/user). It should be appreciated that other types of games or interactive content may be used and various aspects of the invention may be implemented in other formats.

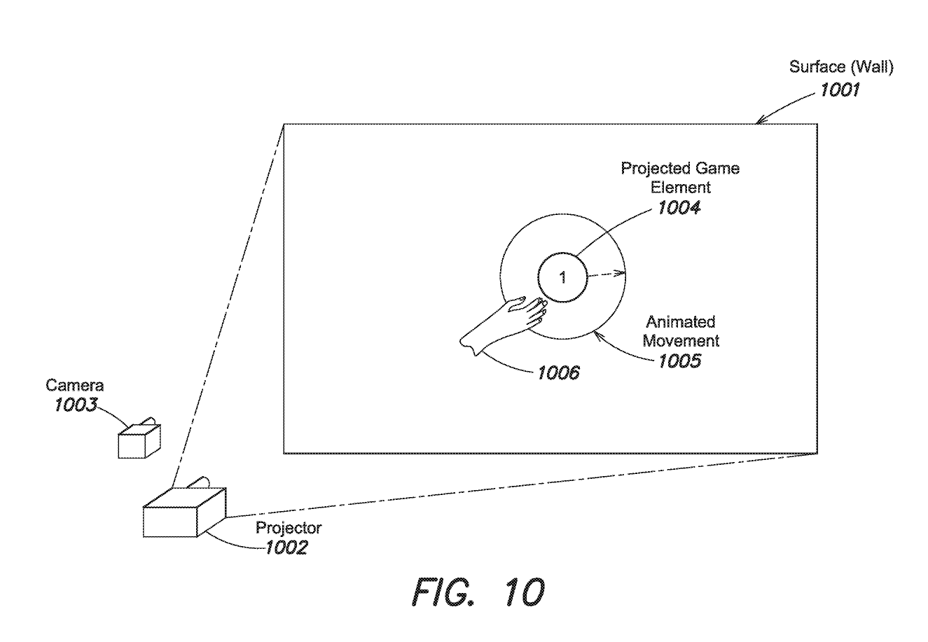

FIG. 10 shows an example user interface that shows an interactive game element according to various embodiments of the present invention. In particular, FIG. 10 shows a surface 1001 on which is displayed interactive content. In one embodiment, the projector 1002 projects a projected game element 1004 that exhibits particular behaviors. When activated by, for example, the user (e.g., by user's hand 1006), the projected game element 1004 may expand responsive to a desired act division by the user and an animated movement of the game element may be shown to the user. For example, when the user places his/her hand on the projected game element, the game element may expand and animate outwards, growing in size until fully activated. For example, projected game element 1004 may expand to an outward size associated with animated movement 1005. In this way, feedback is visually provided to the user as they interact with the game, and the interactive content/game is more easily manipulated by a user.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system comprising:
a projector;
a camera; and
a computer system coupled to the processor, the computer system comprising at least one processor operatively connected to a memory, the at least one processor, when executing is configured to:
operate the projector to display interactive content on a surface;
operate the camera to capture at least image of the displayed interactive content;
an alignment tool adapted to align a component within the captured at least one image and a computer-generated representation of the interactive content.

2. The system according to claim 1, wherein the at least one processor is further configured to store alignment information in the memory.

3. The system according to claim 1, wherein the at least one processor is further configured to present, within a display of the computer, an editor interface including a control that permits a user to associate an interactive element with the component within the display.

4. The system according to claim 3, wherein the system further comprises at least one user interface control that when selected, permits a user to select an interactive element and position the element over a captured aspect of a real-world element, and that causes the at least one user interface to project the element over the real-world element.

5. The system according to claim 3, wherein the camera is adapted to capture a real-world interaction with the projected element.

6. The system according to claim 5, wherein the real-world element is a climbing element within a climbing course.

7. The system according to claim 3, further comprising at least one control that permits the user to define behavior of the interactive element within the display.

8. The system according to claim 7, wherein the behavior comprises visual appearance of the interactive element.

9. The system according to claim 1, wherein the at least one processor is further configured to present, within a display of the computer, one or more controls that permit a user to adjust image processing behavior.

10. The system according to claim 9, wherein the one or more controls comprises at least one control adapted to change sensitivity to a real-world action that triggers a selection of a projected interactive element.

11. The system according to claim 9, wherein the one or more controls comprises at least one control adapted to adjust a lighting control for adjusting parameters relating to processing captured images at a particular site location.

12. In a system comprising a projector, camera and computer system, a method comprising:
operating the projector to display interactive content on a surface;
operating the camera to capture at least image of the displayed interactive content; and
aligning, by an alignment tool provided by the computer system, a component within the captured at least one image and a computer-generated representation of the interactive content.

13. The method according to claim 12, further comprising an act of storing, in a memory of the computer system, alignment information.

14. The method according to claim 12, further comprising an act of displaying, within a display of the computer, an editor interface including a control that permits a user to associate an interactive element with the component within the display.

15. The method according to claim 14, further comprising an act of permitting a user, via at least one user interface control that when selected by the user, to select an interactive element and position the element over a captured aspect of a real-world element, and in response, causing the at least one user interface to project the element over the real-world element.

16. The method according to claim 14, further comprising an act of capturing a real-world interaction with the projected element.

17. The method according to claim 16, wherein the real-world element is a climbing element within a climbing course.

18. The method according to claim 14, further comprising an act of permitting a user, via at least one control, to define behavior of the interactive element within the display.

19. The method according to claim 18, wherein the behavior comprises visual appearance of the interactive element.

20. The method according to claim 12, further comprising an act of presenting, within a display of the computer, one or more controls that permit a user to adjust image processing behavior.

21. The method according to claim 20, wherein the one or more controls comprises at least one control adapted to change sensitivity to a real-world action that triggers a selection of a projected interactive element.

22. The method according to claim 20, wherein the one or more controls comprises at least one control adapted to adjust a lighting control for adjusting parameters relating to processing captured images at a particular site location.

23. A non-volatile computer-readable medium encoded with instructions for execution on a computer system, the instructions when executed, provide a system comprising:
a projector;
a camera; and
a computer system coupled to the processor, the computer system comprising at least one processor operatively connected to a memory, the at least one processor, when executing is configured to:
operate the projector to display interactive content on a surface;
operate the camera to capture at least image of the displayed interactive content;
an alignment tool adapted to align a component within the captured at least one image and a computer-generated representation of the interactive content.
